(19) United States
(12) Patent Application Publication
(10) Pub. No.: US 2022/0017091 A1
(43) Pub. Date: Jan. 20, 2022

(54) MULTIFUNCTIONAL, FLAMEPROOFED TRANSMISSION CONTROL MODULE

(71) Applicant: AIM IP (PTY) LIMITED, Delmas (ZA)

(72) Inventor: Paulus Johannes AUCAMP, Middelburg (ZA)

(21) Appl. No.: 17/294,103

(22) PCT Filed: Nov. 5, 2019
(86) PCT No.: PCT/IB2019/059470

§ 371 Date: May 14, 2021

(30) Foreign Application Priority Data
Nov. 16, 2018 (ZA) 2018/07708

(51) Int. Cl. B60W 30/18; B60W 30/19; G06K 9/00

(52) U.S. Cl. CPC B60W 30/18027; B60W 30/19; B60W 2420/42; G06K 9/00805; B60W 2510/104; B60W 30/18109

(57) ABSTRACT

The invention relates to a multifunctional, flameproofed transmission control module [10] adapted for automatically altering transmission performance based on an alert received from a Proximity Detection System (PDS) [12]. The transmission control module [10] comprises a Proximity Detection Interface (PDI) [14] which is electronically linked to a PDS [12] and which is adapted to reduce transmission performance and vehicle speed the moment an obstacle is detected within a detection zone, and to allow an increase in transmission performance and vehicle speed the moment an obstacle is no longer detected within a detection zone.

### INTRODUCTION

The invention relates to a multifunctional, flameproofed transmission control module adapted for automating a transmission system, particularly suitable for, although not limited to, use on operator controlled industrial machines and utility vehicles used in mining applications.

### BACKGROUND TO THE INVENTION

In terms of South Africa's mining health and safety statutes and regulations, an owner of every mine that is being worked must ensure, as far as reasonably practicable, that the mine is designed, constructed and equipped to provide conditions for safe operation and a healthy working environment, and with communication systems, electrical, mechanical and other equipment as necessary to achieve those conditions. In addition, any person who designs, manufactures, repairs, imports or supplies any article for use at a mine must ensure, as far as reasonably practicable, that the article is safe and without risk to health and safety when used properly; and that it complies with all the requirements in terms of the statutes. It will be appreciated that in mining environments, particularly underground mining operations where conditions are often harsh, it is sometimes a challenge to meet these statutory obligations, particularly since timeous operator visibility of personnel or equipment cannot be guaranteed. One of the ways to address this problem, is to implement Proximity Detection Systems (PDS), also referred to as Collision Avoidance Systems (CAS), on machines and vehicles, particularly on higher speed utility vehicles and industrial machines. Such proximity warning and alert systems are designed to create safe working environments between pedestrian workers and industrial vehicles by creating a detection zone around vehicles, assets, crossings and walkways. Identification tags (which can be radio, magnetic or radar tags), either worn by personnel or fitted to vehicles, are detected by the PDS when they enter or breach the detection zone. Regardless of in any obstruction, the active tags eliminate driver blind spots and poor visibility issues and give industrial vehicle operators and drivers an audible and visual alarm to a pedestrian worker or other obstacle close by. Once a tag is no longer detected in the danger zone or collision risk area, the alarm will stop.

Upon receiving such a PDS alert, the driver must reduce vehicle or machine speed, or bring the vehicle to a halt. Obviously braking systems are implemented on such vehicles to reduce speed, but using only a braking system is not always feasible, especially in high moisture, dusty and muddy environments, where wear and tear is high and brakes can slip or fail. Additional braking considerations include the load of a vehicle and resultant momentum upon braking, the inclination and speed at which the vehicle is travelling, distance from the obstacle, etc. Accordingly, transmission systems are commonly employed to provide a secondary speed reducing or braking functionality on industrial machines and utility vehicles.

It is well-known that a transmission system adapts output of an internal combustion engine to the vehicle's drive wheels. Internal combustion engines need to operate at a relatively high rotational speed, which is inappropriate for starting, stopping and slower travel. The transmission reduces higher engine speed to a slower wheel speed, increasing torque in the process. Often, a transmission has multiple gears or gear ratios with the ability to switch between them as speed varies. This switching may be done manually by the operator, or automatically.

An automatic transmission selects an appropriate gear ratio without any operator intervention. They primarily use hydraulics to select gears, depending on pressure exerted by fluid within the transmission assembly. Rather than using a manually operated clutch to engage/disengage the transmission, as in the case of manual transmission, a fluid flywheel or torque converter is placed in between the engine and transmission.

Although automatic transmissions are easy to use, they are not suited to use in industrial machines and utility vehicles used in mining operations of the type for which the transmission control module of the present invention is designed. Firstly, they may present reliability problems, particularly in harsh flammable mining environments where conventional automatic transmissions, which are not flame-proofed, pose a risk to the mine as they could become an ignition source. In addition, they are often complex and expensive; and may be less fuel-efficient than their manual counterparts due to slippage in the torque converter. However, one of the main problems is that conventional automated transmissions do not include a PDS interpretation interface for automatically adapting transmission, and resultant vehicle speed, to a PDS alert within a tag-detection zone.

The most commonly employed transmission on industrial machines and utility vehicles is a PowerShift™ transmission and/or a manual transmission. A manual transmission, also known as a manual gearbox, uses a driver-operated clutch, usually engaged and disengaged by a foot pedal or hand lever, for regulating torque transfer from an engine to the transmission; and a gear selector that can be operated by hand or foot. A PowerShift™ transmission may be a multi-clutch semi-automatic transmission and is in analogous to two traditional manual transmissions, each with its own clutch, operating in parallel and alternating shifts. Typically, the unit is a six-speed transmission with one clutch acting on the first, third and fifth gear, and the other used for the second, fourth and sixth gear. As the first gear is engaged, the 2-4-6 clutch is disengaged and the second gear cogs are engaged. At the appropriate time, the 1-3-5 clutch is disengaged and the 2-4-6 clutch is engaged. While in second gear, the other side shifts from first to third. The process is repeated with none of the efficiency loss normally associated with torque converters. However, the PowerShift™ transmission is not without problems and have experienced transmission defects, including, but not limited to, bucking, kicking, jerking, harsh engagement and delayed acceleration and lurching. These defects are alleged to be caused, amongst others, by a faulty transmission control module.

A remaining problem with manual transmissions and PowerShift™ transmissions, particularly in underground mining applications, is that their operation relies on operator intervention and response to a PDS alert to initiate “gearing down” for speed reduction. If operator alertness is suboptimal, due to exhaustion, lack of focus, intoxication or the like, it may cause a delay in operator response to a PDS alert, sometimes with dire consequences, including loss of life and/or costly damage to machines and equipment. Moreover, the functionality of “gearing down” also depends on factors such as the weight of the vehicle and the load that it is carrying at that particular moment, which influences the vehicle's momentum; the inclination at which the vehicle is travelling; vehicle speed; environmental factors such as a dry versus wet road surfaces, etc., all of which call for an operator to apply skilful decision making, and often to do so within a short time window. For example, a heavily loaded vehicle, in travelling on a downward inclination, on a wet road surface, at a slow speed, will require a different operator response to gearing down in the event of a PDS alert, than a light vehicle, travelling on an upward inclination, on a dry road surface, at a high speed. If, for example, a heavily loaded vehicle travelling on an upwardly inclined surface is incorrectly geared down, it may result in unnecessary loss of vehicle momentum or engine stalling, which decreases fuel efficiency and may cause engine damage. If, on the other hand, a vehicle travelling on a downwardly inclined surface at a higher speed is incorrectly geared down, it may result in transmission failure and even brake failure.

There is accordingly a need to control transmission automatically and intelligently, in real time and without relying on operator control, skill or response to determine the gearing down protocol, not only in response to vehicle speed, but specifically also in response to a PDS alert from an obstacle in a detection zone, while taking into account factors such as distance from the obstacle, vehicle load, inclination of travel, road surface slippage, etc.

### SUMMARY OF THE INVENTION

In this specification, the term “transmission” shall be interpreted to include mechanical transmissions, having a gearbox that uses gears and gear trains to provide speed and torque conversions from a rotating power source to another device; dual-clutch or multi-clutch transmissions such as a PowerShift™; automated-manual transmissions; and Continuous Variable Transmissions (CVT).

According to the invention there is provided a multifunctional, flameproofed to transmission control module adapted for automatically altering transmission performance based on an alert received from a Proximity Detection System (PDS), the transmission control module comprising a Proximity Detection Interface (PDI) which is electronically linked to a PDS and which is adapted to reduce transmission performance and vehicle speed the moment an obstacle is detected within a detection zone, and to allow an increase in transmission performance and vehicle speed the moment an obstacle is no longer detected within a detection zone.

The transmission control module is adapted proportionally to reduce or increase transmission output and vehicle speed relative to the vehicle's distance from an obstacle. More particularly, the PDI is adapted intelligently to interpret a PDS alert and, taking into account the vehicle's distance from an obstacle, as well as other operating parameters such as vehicle and/or wheel speed, engine load, inclination of travel, degree of acceleration, unfavourable road conditions, etc., to determine which gear change should take place, whether the brake should also be actuated, engine throttle manipulated, or whether the engine should be cut out, without the need for operator intervention and regardless of whether the vehicle is accelerating or decelerating.

The transmission control module is particularly adapted for automation of a PowerShift™ transmission by using information received from a PDS to determine when a gear change should take place based on a vehicle's distance from an obstacle, while also taking into account other operating parameters, which may include vehicle and/or wheel speed, engine load, inclination of travel, degree of acceleration, level of brake actuation, unfavourable road conditions, etc.

The transmission control module also includes a pre-programmable Power Take Off (PTO) switch which is configured to switch off an engine PTO in the event that slip exceeds a predetermined percentage, so as to prevent damage to a clutch pack and protect the engine. The PTO switch is programmable deliberately to delay re-actuation of the PTO after it has been switched off.

The transmission control module also includes a pre-programmable data logger which is adapted to record both operator identity and activity, as well as machine or vehicle operating parameters so as to facilitate accountability and responsibility in the event of an accident and can record actual date and time data associated with such an event, if required. Between Original Equipment Manufacturers (OEM's), PDS manufacturers, and mine operators, accountability and responsibility in the event of an accident is often a highly contested debate, particularly in the event of loss of life or costly machine, equipment or vehicle damage. The data logger is adapted to record, without limitation, the identity of an operator; the duration of such an operator's uninterrupted working of the machine or vehicle; system or component failures, especially at the time of an accident; actual and average vehicle speed and the frequency and extent of over-speeding; the frequency of which the PTO switch was actuated; frequency and severity of brake actuation; efficiency and manner in which a machine or vehicle responded to a PDS alert signal; frequency of service checks; load cell readings from vehicle loads; data capturing of camera images from cameras on the machine or vehicle. Such information is vital for implementation of best practices methodologies, risk assessments, and ultimately to determine accountability and responsibility in the event of a failure.

The transmission control module includes a plurality of input and output portals, and is electronically linked to the vehicle's transmissions electronics, including shift solenoids, pressure control solenoid and/or torque converter clutch solenoid, via an intermediary junction box.

The transmission control module may operatively be associated with a flameproofed gear selector such that the control module is electronically located between the flameproofed gear selector and the transmission electronics and associated solenoids, the arrangement being such that direct coupling between the gear selector and solenoids is interrupted by the intermediary control module so that the control module controls gear change in response to a PDS alert signal regardless of positioning of the gear selector.

The invention includes an automated PowerShift™ transmission including the transmission control module as herein described.

### SPECIFIC EMBODIMENT OF THE INVENTION

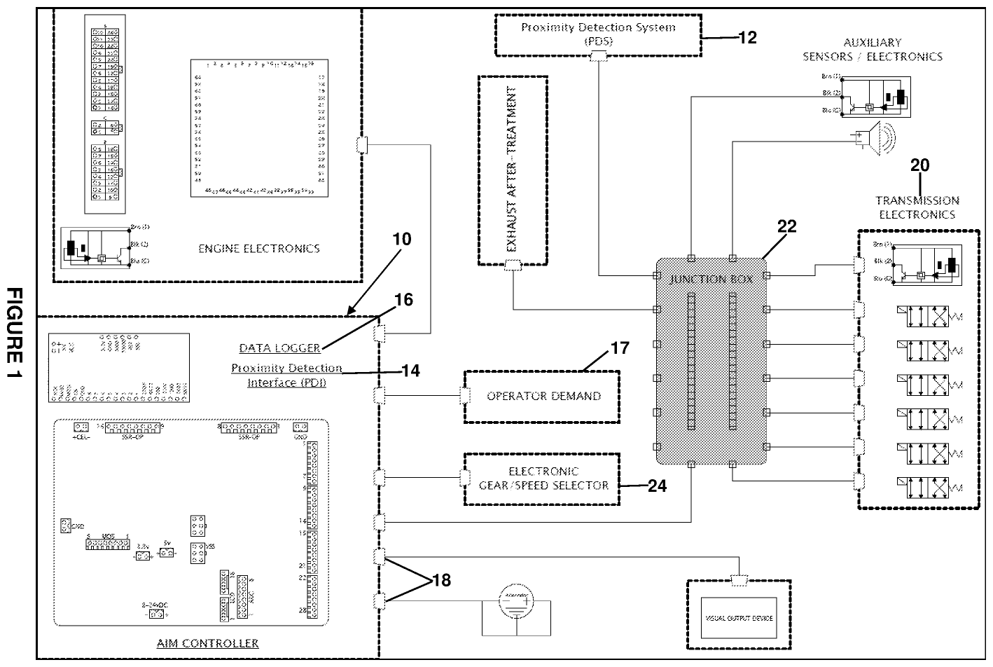

Without limiting the scope thereof, the invention will now further be illustrated and exemplified with reference to the accompanying FIG. 1, which is a schematic illustration of a manual-automated transmission and integrated control module according to the invention.

A multifunctional, flameproofed transmission control module according to the invention is designated by reference numeral [10]. The control module [10] is adapted for in automatically altering transmission performance based on an alert received from a Proximity Detection System (PDS) [12]. The transmission control module [10] comprises a Proximity Detection Interface (PDI) [14] which is electronically linked to a PDS [12] and which is adapted to reduce transmission performance and vehicle speed the moment an obstacle is detected within a detection zone, and to allow an increase in transmission performance and vehicle speed the moment an obstacle is no longer detected within a detection zone.

The control module [10] includes a pre-programmable data logger [16] which is adapted to record both operator identity (if required) and activity, as well as machine or vehicle operating parameters and component conditions so as to facilitate accountability and responsibility in the event of an accident.

The control module [10] also includes a plurality of input and output portals [18], and is electronically linked to the vehicle's transmissions electronics [20], including shift solenoids, pressure control solenoid and/or torque converter clutch solenoid, via an intermediary junction box [22].

The control module [10] may operatively be associated with a flameproofed gear selector [24] such that the control module [10] is electronically located between the flameproofed gear selector [24] and the transmission electronics and associated solenoids [20], the arrangement being such that direct coupling between the gear selector [24] and solenoids [20] is interrupted by the intermediary control module [10] so that the control module [10] controls gear change in response to a PDS [12] alert signal, regardless of positioning of the gear selector [24].

It will be appreciated that other embodiments of the invention are possible without departing from the spirit or scope of the invention as defined in the claims.

1. A multifunctional, flameproofed transmission control module adapted for automatically altering transmission performance based on an alert received from a Proximity Detection System (PDS), the transmission control module comprising a Proximity Detection Interface (PDI) which is electronically linked to a PDS and which is adapted to reduce transmission performance and vehicle speed the moment an obstacle is detected within a detection zone, in real time, and to allow an increase in transmission performance and vehicle speed the moment an obstacle is no longer detected within a detection zone.

2. The transmission control module according to claim 1 wherein the control module is adapted proportionally to reduce or increase transmission output and vehicle speed relative to the vehicle's distance from an obstacle.

3. The transmission control module according to claim 2 wherein the PDI is adapted intelligently to interpret a PDS alert and, taking into account a vehicle's operating parameters, to determine which gear change should take place, whether the brake should also be actuated, engine throttle manipulated, or whether the engine should be cut out, without the need for operator intervention and regardless of whether the vehicle is accelerating or decelerating.

4. The transmission control module according to claim 3 wherein the control module is particularly adapted for automation of a PowerSoft™ transmission by using information received from a PDS to determine when a gear change should take place based on a vehicle's operating parameters.

5. The transmission control module according to claim 3 wherein the operating parameters are selected from a group including distance from an obstacle, vehicle and/or wheel speed, engine load, inclination of travel, degree of acceleration, level of brake actuation, and unfavourable road conditions.

6. The transmission control module according to claim 1 wherein the control module includes a pre-programmable Power Take Off (PTO) switch which is configured to switch off an engine PTO in the event that slip exceeds a predetermined percentage.

7. The transmission control module according to claim 6 wherein the PTO switch is programmable deliberately to delay re-actuation of the PTO after it has been switched off due to an overload condition.

8. The transmission control module according to claim 1 wherein the control module includes a pre-programmable data logger which is adapted to record both operator identity and activity, as well as machine or vehicle operating parameters.

9. The transmission control module according to claim 6 wherein the data logger is adapted to record, without limitation, identity of an operator; duration of such an operator's uninterrupted working of the machine or vehicle; system or component failures, especially at the time of an accident; actual and average vehicle speed and frequency and extent of over-speeding; frequency of which a PTO switch was actuated; frequency and severity of brake actuation; efficiency and manner in which a machine or vehicle responded to a PDS alert signal; frequency of service checks; load cell readings from vehicle loads; data capturing of camera images from cameras on the machine or vehicle.

10. The transmission control module according to claim 1 wherein the control module includes a plurality of input and output portals, and is electronically linked to a vehicle's transmission electronics, including shift solenoids, pressure control solenoid and/or torque converter clutch solenoid, via an intermediary junction box.

11. The transmission control module according to claim 10 wherein the control module is operatively associated with a flameproofed gear selector such that the control module is electronically located between the flameproofed gear selector and the transmission electronics and associated solenoids, the arrangement being such that direct coupling between the gear selector and solenoids is interrupted by the intermediary control module so that the control module controls gear change in response to a PDS alert signal regardless of positioning of the gear selector.

12. An automated PowerSoft™ transmission including the transmission control module according to claim 1.
